(19) United States
(12) Patent Application Publication
(10) Pub. No.: US 2008/0241622 A1
(43) Pub. Date: Oct. 2, 2008

(54) ELECTRONIC APPLIANCE AND FUEL CELL UNIT

(75) Inventors: Kei MATSUOKA, Kawasaki-shi (JP); Terumasa Nagasaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/047,651

(22) Filed: Mar. 13, 2008

(30) Foreign Application Priority Data
Mar. 27, 2007 (JP) 2007-081492

(51) Int. Cl. H01M 8/04

(52) U.S. Cl. 429/26

(57) ABSTRACT

A fuel cell unit is attachable to a main unit of an electronic appliance having an air-inhaling inlet for inhaling open air for cooling internal components and an area where no air-inhaling inlet is formed, and includes: a fuel cell that generates water upon power generation and supplies power to the electronic appliance; and a vapor exhaust outlet for exhausting vapor containing the generated water at a position lower, in a posture in general use, to the area of the main unit where no air-inhaling inlet is formed.

### CROSS-REFERENCE TO RELATED APPLICATIONS

This application is based upon and claims the benefit of priority from Japanese Patent Application No. 2007-081492, filed on Mar. 27, 2007, the entire content of which are incorporated herein by reference.

### BACKGROUND

1. Field

One embodiment of the invention relates to fuel cell unit for supplying electric power to an electronic appliance and an electronic appliance equipped with the fuel cell unit.

2. Description of the Related Art

Many of electronic appliances have an air exhaust outlet for exhausting evolution of heat inside to the outside, and the air having functioned to cool the electronic heating inside the electronic appliances are exhausted through the air exhaust outlet. The air functioning as a coolant is inhaled through various positions of the housing of the electronic appliance.

Although the coolant of the open air may be inhaled through an exclusive feed opening provided in an electronic appliance, the coolant is in many cases inhaled into the electronic appliance through openings formed for ports for connecting various external devices or formed for drives of optical recording media such as CD-ROM. Examples of such openings include a connector for external CRT, a USB port, a modem port, a LAN port, a slot for taking out an SD card or PA card, a head-phone jack, a microphone jack, an IEEE1394 port, an RS-232 port, an RS-422 port, an opening for taking out a CD-ROM drive, an opening for taking out DVD-ROM drive, an opening for taking out an HD-DVD drive, and an AC electric source connector.

Also, in the case of using a fuel cell as an electric source for driving an electronic appliance, there is provided a vapor exhaust outlet for exhausting water generated upon power generation as, for example, water vapor. In some cases, the gas exhausted through the vapor exhaust outlet can give users of the electronic appliance an unpleasant feeling depending upon the temperature or direction of the exhausted gas. In order not to give users such unpleasant feeling, JP-A-2006-196269 discloses a device which directs the exhausted gas through the vapor exhaust outlet in a direction different from that of the operating screen of the electronic appliance facing a user.

With electronic appliances using a fuel cell, the water vapor exhausted from the fuel cell can be inhaled into the inside of the electronic appliance together with air which functions as a coolant for the electronic appliance. In such cases, water vapor is inhaled together with the air through openings formed in ports for connecting various external devices or formed in drives of optical recording media such as CD-ROM.

In such cases, functions of the ports or drives can be spoiled when the water vapor exhausted from the fuel cell comes into contact with the ports or drives to condensate. In particular, metal portions exposed to outside can be oxidized. Further, when the water vapor inhaled into the inside of the electronic appliance together with the air comes into contact with electronic parts within the electronic appliance to condensate, there arises electrical braking of the electronic parts or damage of the performance of the electronic parts themselves.

### SUMMARY

According to a first aspect of the present invention, there is provided a fuel cell unit that is attachable to a main unit of an electronic appliance having an air-inhaling inlet for inhaling open air for cooling internal components and an area where no air-inhaling inlet is formed, the fuel cell unit including: a fuel cell that generates water upon power generation and supplies power to the electronic appliance; and a vapor exhaust outlet for exhausting vapor containing the generated water at a position lower, in a posture in general use, to the area of the main unit where no air-inhaling inlet is formed.

According to a second aspect of the present invention, there is provided a fuel cell unit that is attachable to a main unit of an electronic appliance having an air-inhaling inlet for inhaling open air for cooling internal components, the fuel cell unit including: a fuel cell that generates water upon power generation and supplies power to the electronic appliance; and a vapor exhaust outlet for exhausting vapor containing the generated water at a position apart from the main unit in a horizontal direction with a predetermined distance in a posture in general use.

According to a third aspect of the present invention, there is provided a fuel cell unit that is attachable to a main unit of an electronic appliance having an air-inhaling inlet for inhaling open air for cooling internal components, the fuel cell unit including: a fuel cell that generates water upon power generation and supplies power to the electronic appliance; a vapor exhaust outlet for exhausting vapor containing the generated water; and a dew condensation preventing shroud that is provided at a position upper, in a posture in general use, to a position where the vapor exhaust outlet is formed and covers the air-inhaling inlet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a first exemplary embodiment of an electronic appliance in accordance with the present invention.

FIG. 2 is a perspective view showing a second exemplary embodiment of an electronic appliance in accordance with the present invention.

FIG. 3 is a perspective view showing a third exemplary embodiment of an electronic appliance in accordance with the present invention.

FIG. 4 is a perspective view showing a fourth exemplary embodiment of an electronic appliance in accordance with the present invention.

FIG. 5 is a perspective view showing a fifth exemplary embodiment of an electronic appliance in accordance with the present invention.

### DETAILED DESCRIPTION

An embodiment of the present invention will be described by referring to an information processing apparatus and accompanying drawings.

The same reference number or sign is assigned to the same or analogous structure, with omitting repeated descriptions.

### First Exemplary Embodiment

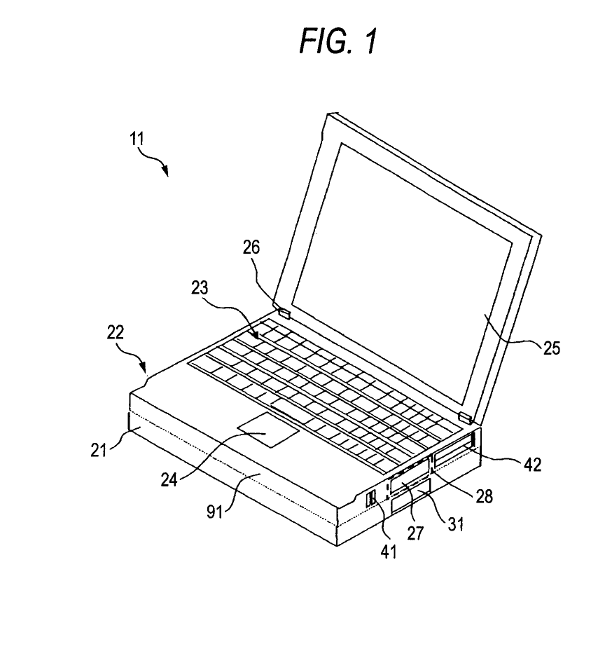

FIG. 1 is a perspective view showing a first exemplary embodiment of an electronic appliance in accordance with the present invention.

The electronic appliance of this exemplary embodiment is a notebook personal computer 11. The notebook personal computer 11 has a fuel cell unit 21 and a computer unit (main unit) 22.

The fuel cell unit 21 is flat, and the computer unit 22 is positioned above the fuel cell unit 21. The fuel cell unit 21 and the computer unit 22 are assembled into one body.

The computer unit is equipped with a key board 23 and a pointing device of touch pad 24. Also, the personal computer 22 is equipped with a display unit 25. The display unit 25 is rotatably attached by means of a hinge 26 to be opened and closed. A user of the notebook personal computer 11 operates it from the opposite side of the display unit 25 to the key board 23, with the hinge 26 being in an opened state. The side of the notebook personal computer 11 facing the operating user is referred to a user-facing side 91.

The computer unit 22 has a USB port 41 and a card slot 42. The USB port 41 is a port for connecting an external device, and the card slot 42 is a slot for mounting a card-type external device. The card-type external device includes a flash memory and a PC card.

The fuel cell unit 21 is provided with a fuel cell 100 therein, the fuel cell having an anode, a cathode, and an electrolyte membrane sandwiched therebetween. The fuel cell unit 21 generates water vapor upon power generation.

The fuel cell unit 21 is equipped with a vapor exhaust outlet 31 on the side other than the user-facing side 91. The part positioned perpendicularly above the vapor exhaust outlet 31 when the appliance is placed in a posture in general use is an area 28 where no air-inhaling inlet exists. The area 28 where no air-inhaling inlet exists means an area where no opening for inhaling the coolant for the computer unit 22, air, is formed. That is, ports for connecting various external devices and drives for optical media such as CD-ROM, which provide openings of connecting the computer unit 22 to the outside for inhaling the air, are not disposed in the area 28 where no air-inhaling inlet exists.

In the computer unit 22 of this exemplary embodiment, the air having cooled the inside of the computer unit 22 is exhausted through an air exhaust outlet 27 of a cooling fan. Additionally, the air-exhaust outlet 27 of the cooling fan also forms an opening which connects the computer unit 22 to the outside but, since air is exhausted through this part, no air is usually inhaled therethrough.

The port and the drive, such as the USB port 41 and the card slot 42, which is provided with slots for inhaling open air to cool inner components of the computer unit 22. In the embodiment, the port and the drive (the USB port 41 and the card slot 42) serves as an air-inhaling inlet for inhaling open air for cooling internal components. The USB port 41 and the card slot 42 are provided in areas other than the area 28 where no air-inhaling inlet exists.

Since the air exhaust outlet 27 of the cooling fan is provided perpendicularly above the vapor exhaust outlet 31 as described above, openings formed in ports for connecting various external devices and drives for optical media are to be provided in parts other than the part perpendicularly above the vapor exhaust outlet 31. Accordingly, the possibility that the water vapor exhausted, upon power generation by the fuel cell unit 21, from the vapor exhaust outlet 31 comes into contact with metal portions such as the connecting portion of the USB port 41 or is inhaled into the inside of the computer unit 22 together with the coolant of air is reduced.

Thus, the possibility that the water vapor exhausted from the fuel cell comes into contact with the port or drive or with the electronic parts inside the computer unit 22 to condensate is reduced. Hence, the possibility of the water vapor generated from the fuel cell to spoil functions of the electronic appliance using the fuel cell is reduced.

In this exemplary embodiment, the notebook personal computer 11 is supposed to be used so that the key board 23 is placed almost horizontally. Additionally, when the notebook personal computer 11 is used in a short time during which the amount of dew condensation caused by contact of the water vapor exhausted from the fuel cell with the port or drive or with the electronic parts inside the computer unit 22 is negligible, the notebook personal computer 11 may be used in different posture with no problems. In the case where the notebook personal computer 11 is supposed to be used for a long time in a posture other than that wherein the key board 23 is placed almost horizontally, it suffices that the part positioned perpendicularly above the vapor exhaust outlet 31 in the supposed posture be the area 28 where no air-inhaling inlet exists.

Since the vapor exhaust outlet 31 is provided on the side other than the user-facing side 91, water vapor is not exhausted toward the user of the notebook personal computer 11, and there exists only a small possibility of the water vapor exhausted from the fuel cell to give an unpleasant feeling to the user.

In the above, descriptions have been given with respect to USB port and card slot, the same applies to the case of providing in an electronic appliance ports or drives which form openings leading to the inside, such as a modem port, a CRT port, an LAN port, a head-phone jack, a microphone jack, an IEEE1394 board, an RS-232 port, an RS-422 port, an outlet for taking out a CD-ROM drive, an outlet for taking out a DVD-ROM, an outlet for taking out an HD-DVD drive, and an AC electric source connector.

### Second Exemplary Embodiment

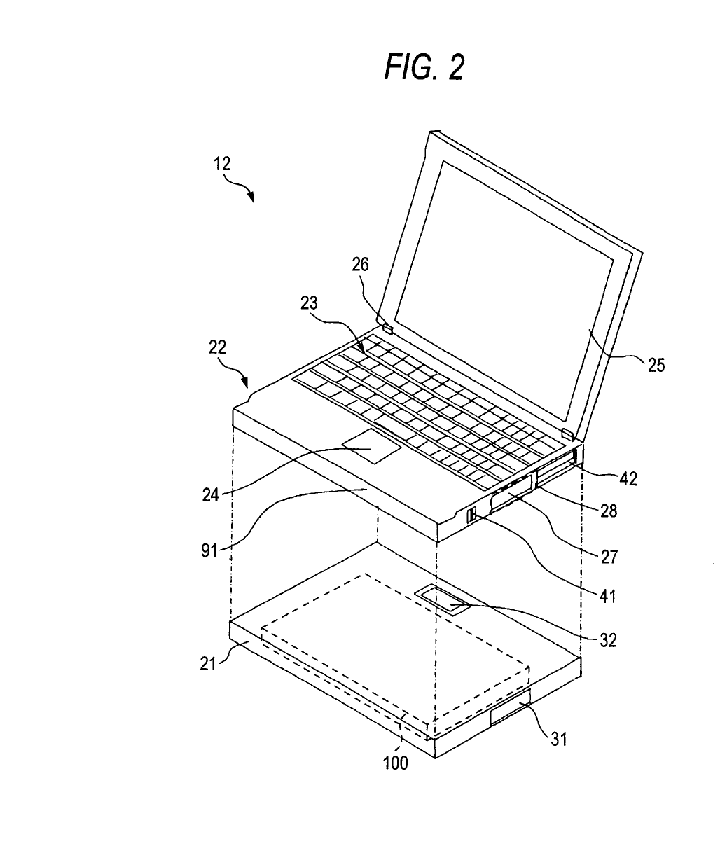

FIG. 2 is a perspective view showing a second exemplary embodiment of the electronic appliance in accordance with the present invention.

The electronic appliance of this exemplary embodiment is a notebook personal computer 12 wherein a fuel cell 21 is in a form attachable to a computer unit 22. The fuel cell unit 21 is provided with an electric source-providing connector 32, and electric power is fed to the computer unit 22 via the electric source-providing connector 32.

Additionally, FIG. 2 is a view showing the state wherein the fuel cell unit 21 and the computer unit 22 are separated from each other and, when the fuel cell unit 21 is attached to the computer unit 22, there results almost the same one as the notebook personal computer 11 of the first exemplary embodiment shown in FIG. 1.

In this notebook personal computer 12, the area 28 where no air-inhaling inlet is provided perpendicularly above the vapor exhaust outlet 31 is provided as in the first exemplary embodiment. Accordingly, the possibility that the water vapor exhausted from the fuel cell unit 21 comes into contact with metal portions such as the connecting portion of the port or is inhaled into the inside of the computer unit 22 is reduced. Thus, the possibility that the water vapor exhausted from the fuel cell spoils functions of the electronic appliance using the fuel cell is reduced.

### Third Exemplary Embodiment

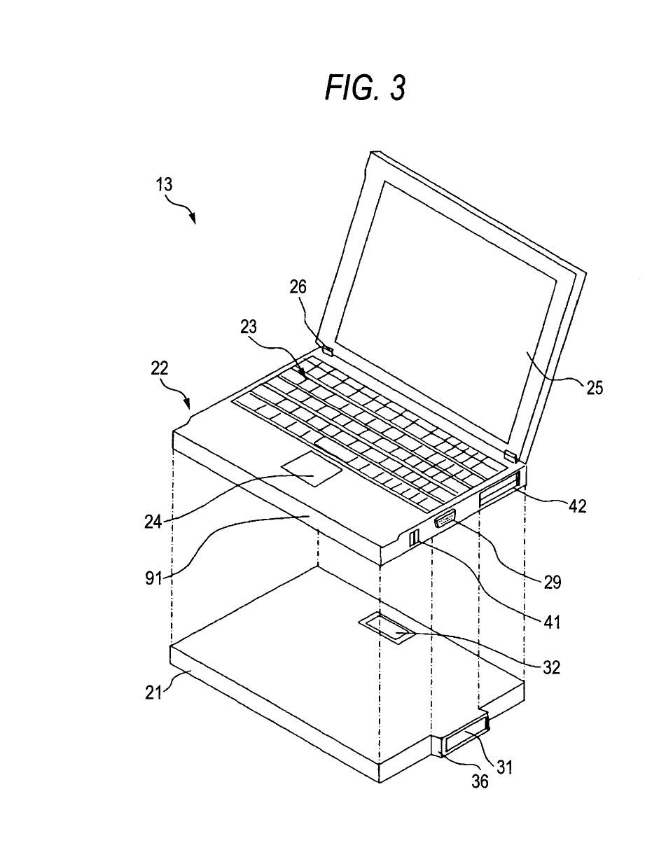

FIG. 3 is a perspective view showing a third exemplary embodiment of the electronic appliance in accordance with the present invention.

The electronic appliance of this exemplary embodiment is a notebook personal computer 13 wherein a fuel cell 21 is in a form attachable to a computer unit 22. The fuel cello unit 21 is provided with an electric source-providing connector 32, and electric power is fed to the computer unit 22 via the electric source-providing connector 32.

The fuel cell unit 21 has an about rectangular projection shape and has an about the same projection shape as that of the computer unit 22, with a duct 36 extending from the side surface thereof. The vapor exhaust outlet 31 is provided at the end of the duct 36. The computer unit 22 is equipped with a CRT port 29 at the part positioned perpendicularly above the duct 36.

In this exemplary embodiment, the vapor exhaust outlet 31 is provided at a position apart from the computer unit 22 in the horizontal direction by the length of the duct 35 and, even when water vapor exhausted from the vapor exhaust outlet 31 arises upward, the possibility of its contacting with metal parts such as ports is small. In addition, the possibility of its being inhaled into the inside of the computer unit 22 is reduced. Thus, the possibility that the electronic appliance using the fuel cell is spoiled is reduced. Additionally, here, although descriptions are made by taking the CRT port as an example, the same applies to other kinds of ports or to drives of optical media.

As is described above, even in the case where ports for connecting external devices or drives of optical media must unavoidably be disposed perpendicularly above the vapor exhaust outlet 31, the possibility that functions of the electronic appliance using the fuel cell are spoiled by water vapor exhausted from the fuel cell can be reduced.

Additionally, though the vapor exhaust outlet 31 is disposed at the position apart from the computer unit 22 in the horizontal direction by means of the duct 36, it is also possible to extend the entire side surface forming the vapor exhaust outlet 31 by the same length as that of the duct 36 so that the fuel cell unit 21 has totally a rectangular projection shape.

### Fourth Exemplary Embodiment

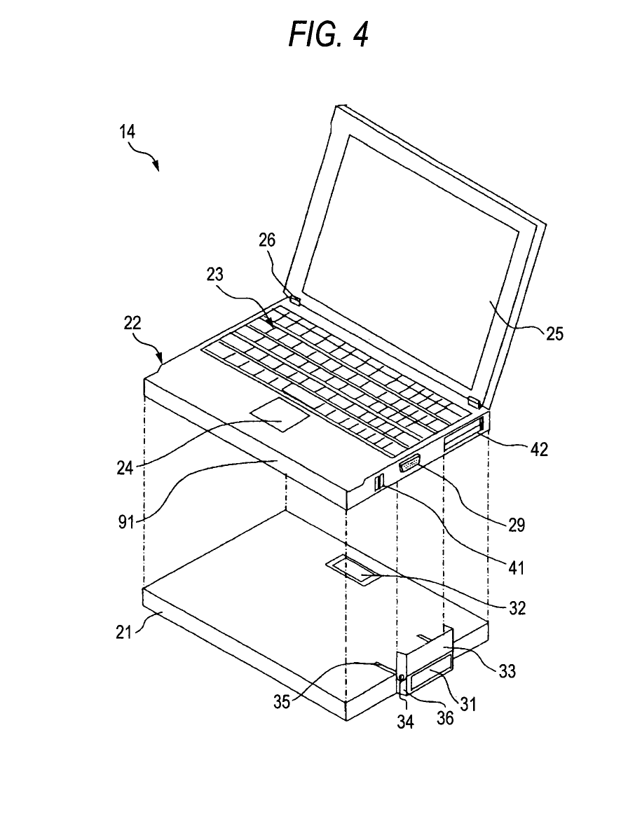

FIG. 4 is a perspective view showing a fourth exemplary embodiment of the electronic appliance in accordance with the present invention.

The electronic appliance of this exemplary embodiment is a notebook personal computer 14 wherein a dew condensation preventing shroud 33 extending upward from the duct 35 is added to the notebook personal computer 13 of the third exemplary embodiment.

The dew condensation preventing shroud 33 and the duct 36 are formed so that the dew condensation preventing shroud 33 does not interfere with the CRT port 29.

Slits 35 are provided on the upper surface of the fuel cell unit 21 so that, when the fuel cell unit 21 is removed from the computer unit 22, the dew condensation preventing shroud 33 can be rotated with the connecting part 34 being the center to fold. Thus, when the fuel cell unit 21 is removed from the computer unit 22, folding of the dew condensation preventing shroud 33 improves portability of the unit.

In this exemplary embodiment, the dew condensation preventing shroud 33 is provided perpendicularly above the vapor exhaust outlet 31, and hence the possibility of its contact with metal parts such as connecting parts of ports and its being inhaled into the inside of the computer unit 22 is reduced. Thus, the possibility that the electronic appliance using the fuel cell is spoiled is reduced.

As is described above, even in the case where ports for connecting external devices or drives of optical media must unavoidably be disposed perpendicularly above the vapor exhaust outlet 31, the possibility that functions of the electronic appliance using the fuel cell are spoiled by water vapor exhausted from the fuel cell can be reduced.

### Fifth Exemplary Embodiment

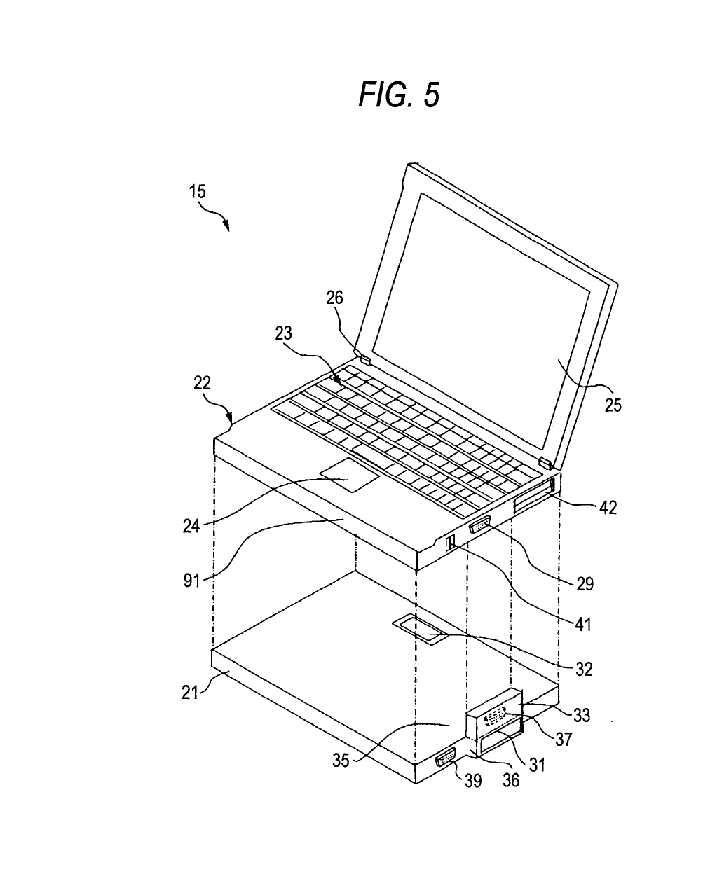

FIG. 5 is a perspective view showing a fifth exemplary embodiment of the electronic appliance in accordance with the present invention.

The electronic appliance of this exemplary embodiment is a notebook personal computer 15 wherein a connector 37 and an alternative CRT port 39 are added to the notebook personal computer 13 of the third exemplary embodiment.

The connector 37 is contained within the dew condensation preventing shroud 33. The connector 37 can be plugged into the CRT port 29 and is electrically connected to the alternative CRT port 39. That is, an external CRT can be connected to the CRT port 29 by connecting the external CRT to the alternative CRT port 39.

In this exemplary embodiment, the CRT port positioned perpendicularly above the vapor exhaust outlet 31 is covered by the dew condensation preventing shroud 33, and hence the possibility of its contact with metal parts such as connecting parts of ports and its being inhaled into the inside of the computer unit 22 is reduced. Thus, the possibility that the electronic appliance using the fuel cell is spoiled is reduced.

In addition, the functions of the CRT port covered by the dew condensation preventing shroud 33 are replaced by the alternative CRT port 39 provided at the different position, and use of external CRT is not limited. Additionally, though the above descriptions here are given by taking the CRT port as an example, the same applies to other kinds of ports to be connected to external devices.

As is described above, even in the case where ports for connecting external devices must unavoidably be disposed perpendicularly above the vapor exhaust outlet 31, it is possible by covering the part to prevent the water vapor from coming into contact with the port or from being inhaled into the inside of the electronic appliance. In addition, use of an external device using the port is not restricted owing to the alternative port provided in the fuel cell unit 21 for substituting for the covered port.

### Other Exemplary Embodiments

The first through fifth exemplary embodiments are merely illustrative, and do not limit the scope of the claimed invention. For example, the present invention can be applicable to other electronic appliances using a fuel cell as an electric source for driving those electronic appliances, such as portable video player for reproducing video images recorded on portable optical media and portable TV sets. Further, it is also possible to perform a combination of the characteristics of individual exemplary embodiments.

What is claimed is:

1. A fuel cell unit that is attachable to a main unit of an electronic appliance having an air-inhaling inlet for inhaling open air for cooling internal components and an area where no air-inhaling inlet is formed, the fuel cell unit comprising:
a fuel cell that generates water upon power generation and supplies power to the electronic appliance; and
a vapor exhaust outlet for exhausting vapor containing the generated water at a position lower, in a posture in general use, to the area of the main unit where no air-inhaling inlet is formed.

2. A fuel cell unit that is attachable to a main unit of an electronic appliance having an air-inhaling inlet for inhaling open air for cooling internal components, the fuel cell unit comprising:
a fuel cell that generates water upon power generation and supplies power to the electronic appliance; and
a vapor exhaust outlet for exhaust vapor containing the generated water at a position apart from the main unit in a horizontal direction with a predetermined distance in a posture in general use.

3. A fuel cell unit that is attachable to a main unit of an electronic appliance having an air-inhaling inlet for inhaling open air for cooling internal components, the fuel cell unit comprising:
a fuel cell that generates water upon power generation and supplies power to the electronic appliance;
a vapor exhaust outlet for exhausting vapor containing the generated water; and
a dew condensation preventing shroud that is provided at a position upper, in a posture in general use, to a position where the vapor exhaust outlet is formed and covers the air-inhaling inlet.

4. An electronic appliance comprising:
a main unit that has:
an air-inhaling inlet for inhaling open air for cooling internal components;
an area where no air-inhaling inlet is formed; and
an air exhaust outlet for exhausting air inhaled through the air-inhaling inlet; and
a fuel cell unit according to claim 1.

5. The electronic appliance according to claim 4, wherein the air exhaust outlet is formed at a position upper to the vapor exhaust outlet in the posture in general use.

6. An electronic appliance comprising:
a main unit that has an air-inhaling inlet for inhaling open air for cooling internal components; and
a fuel cell unit according to claim 2.

7. An electronic appliance comprising:
a main unit that has an air-inhaling inlet for inhaling open air for cooling internal components;
a fuel cell unit according to claim 3.

8. The electronic appliance according to claim 7, wherein the air-inhaling inlet is formed in a port for connecting external devices to the main unit,
wherein the dew condensation preventing shroud entirely covers the port, and
wherein the fuel cell unit is equipped with a connector attachable to the port covered by the dew condensation preventing shroud and an alternative port that is electrically connected to the connector.
